(19) United States
(12) Patent Application Publication
(10) Pub. No.: US 2010/0096911 A1
(43) Pub. Date: Apr. 22, 2010

(54) Energy Wheel

(76) Inventor: Sherif Fahmy Eldeeb, Mounds View, MN (US)

Correspondence Address: Sherif Eldeeb, P.O. Box 120942, St. Paul, MN, 55112, US

(21) Appl. No.: 12/253,313

(22) Filed: Oct. 17, 2008

(51) Int. Cl. B60B 27/00; B62M 1/10; B60B 19/00

(52) U.S. Cl. 301/105.1; 280/217; 301/6.5

(57) ABSTRACT

A wheel hub for capturing energy created by road bumps and converting that into energy to be used in moving a vehicle in it's current direction of motion. Energy return is accomplished by elastic spring means, although the physical principle of operation is not directly obvious. Any road shock imparted upon the wheel will result in a radial displacement of an outer wheel hub and thus a radial force toward the center of the wheel. The radial force will be released as an axial rotation imparted upon a wheel hub assembly, thus increasing the axial speed in the current direction of motion. The principle is similar to that causing the earth to rotate around the sun. The wheel hub assembly will not wobble erratically since there is a dampening component by virtue of a vehicles weight and moment of inertia of a rotating wheel. Additionally, total shock absorbtion, is increased.

### RELATED APPLICATIONS

The present application is related to U.S. Pat. No. 6,701,985, issued Oct. 15, 2008, for ENERGY RETURN WHEEL SYSTEMS AND METHODS, by Brian A. Russell, included by reference herein.

The present application is related to U.S. Pat. No. 6,860,034, issued Oct. 15, 2008, for ENERGY RETURN SOLE FOR FOOTWEAR, by Schmid; Rainer K., included by reference herein.

The present application is related to U.S. Pat. No. 7,415,874, issued Oct. 15, 2008, for METHOD AND SYSTEM FOR GENERATING ELECTRICAL ENERGY WITHIN A VEHICLE TYRE, by Mancosu; Federico (Milan, IT), Rampana; Barbara (Milan, IT), Mariani; Fabio (Milan, IT), Calatroni; Andrea (Milan, IT), included by reference herein.

Before the invention of pneumatic tires, elastic spring mechanisms were devised for absorbing impact. Those devices were subsequently discarded because of their complexity and high maintenance versus pneumatic tires. The energy conserving property of said devices was never utilized nor were all the aforementioned configurations as described by the present invention. The present invention comprises a new use for some of those wheels with identical configurations causing radially symmetric inward spring force.

### FIELD OF THE INVENTION

The present invention relates to energy conservation and, more particularly, to energy conservation in moving vehicles with wheels.

### BACKGROUND OF THE INVENTION

In a critically energy intensive world, consumers are looking for a way to reduce energy consumption. The present invention reduces energy consumption in a wheeled vehicle by absorbing shock and converting to energy for moving a wheeled vehicle, thus reducing total energy consumption in a wheeled vehicle.

Many solutions for energy conservation exist, but that of converting road bumps into energy in a simple manner are few. There is an invention by Pirelli, converting shock absorption into electrical energy for later use.

The prior art inventions aren't close to the same method used. The prior art consists of energy return inventions comprising simple springs operating in a standard manner. A prior art tire assigned to Pirelli brand tires is used for collecting energy with piezoelectric devices. It has many moving parts, an energy storage system, and a corresponding control system.

It is therefore an object of the invention to conserve energy used by a wheeled vehicle.

It is another object of the invention to convert road bump shocks into energy used to move a wheeled vehicle.

It is another object of the invention to provide a simple and long lasting system for energy conservation for a wheeled vehicle.

It is another object of the invention to provide an improved shock absorption system for a smoother ride.

### SUMMARY OF THE INVENTION

In accordance with the present invention, there is provided a wheel hub for capturing energy created by road bumps and converting that into energy to be used in moving a vehicle in it's current direction of motion. The invention utilizes elastic spring means arranged in a radially symmetric manner. Any shock absorbed is converted into radially inward force in the elastic spring means which is dampened by increasing the rotational velocity of the wheel while in motion.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an energy wheel hub assembly;

FIG. 2 is a front view of a three by one trefoil shaped elastic spring means;

FIG. 3 is a perspective view of a single wheel split segment elastic bag energy wheel, single wheel elastic bag energy wheel, and alternative dual wheel elastic bag energy wheel;

FIG. 4 is a perspective view of a slide cylinder supported elastic cord energy wheel and pneumatic cylinder energy wheel;

FIG. 5 is a perspective view of a straight elastic bar spring energy wheel, curved elastic bar energy wheel, and alternative dual wheel elastic bar energy wheel;

FIG. 6 is a front view of an examplary intermediary inner wheel rotor configuration with elastic bar springs; and

FIG. 7 is a front view of a toroidally configured elastic spring energy wheel in an intermediary inner rotor configuration.

For purposes of clarity and brevity, like elements and components will bear the same designations and numbering throughout the FIGURES.

### DESCRIPTION OF THE PREFERRED EMBODIMENT

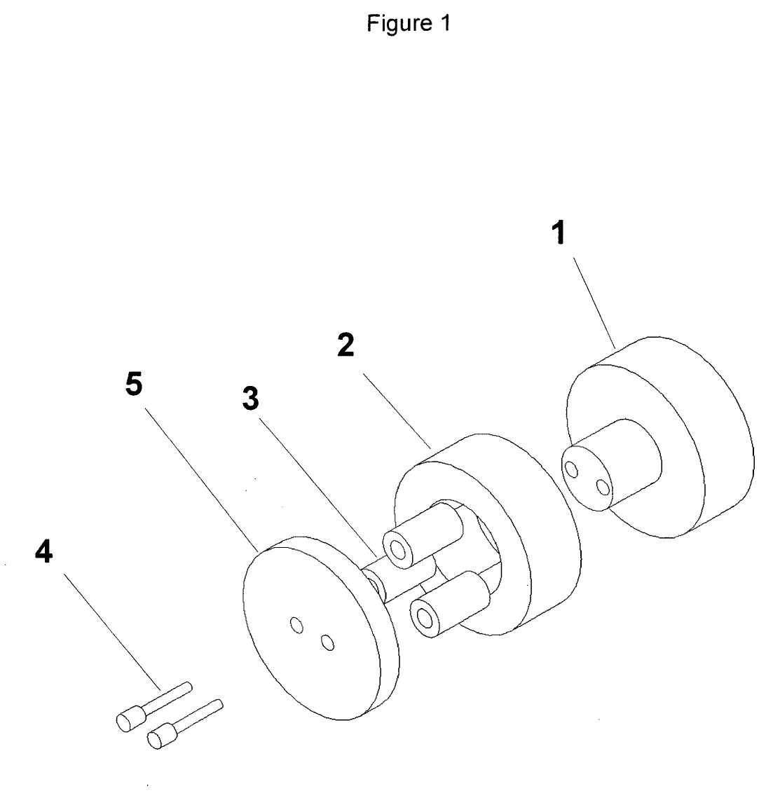

FIG. 1 is a perspective view of an energy wheel hub assembly. Energy return is accomplished by an elastic spring means 3. elastic spring means 3 are any material or mechanisms having elastic properties. Although the physical principle of operation is not directly obvious, any road shock imparted upon the wheel will result in a radial displacement of an outer wheel hub rotor 2 and thus a resultant elastic radial force toward the center of the wheel. The radial force will be released as an axial rotation imparted upon a wheel hub assembly, thus increasing the axial speed in the current direction of motion. The principle is similar to that causing the earth to rotate around the sun. The energy wheel hub assembly will not wobble erratically since there is a dampening component by virtue of a vehicles weight, which dampens any upwards wobble and moment of inertia of a rotating wheel, which dampens any wobble having a rotation reversing effect.

The energy wheel hub assembly consists of an inner wheel rotor 1 fastened to elastic spring means 3 with fastening means. Alternatively a recessed groove may be cut into the inner wheel rotor 1 and a corresponding recessed groove in the outer wheel hub rotor 2 for holding elastic spring means 3. elastic spring means 3 must also be rigid enough to not be pinched between the outer wheel hub rotor 2 and wheel hub assembly components during operational movement. This can happen with soft rubber elastic spring means 3. The bore diameter in outer wheel hub rotor 2 and inner wheel rotor 1 inner shaft diameter must be selected so that a energy wheel hub assembly does not come apart during operation. Given an inner wheel rotor 1 inner shaft diameter, and elastic spring means 3 with known fully compressed and free state distances, an outer wheel hub rotor 2 bore diameter shall be at least as large as the sum of inner wheel rotor 1 inner shaft diameter, and double elastic spring means 3 fully compressed distance. An additional distance shall be included for operational elastic displacements. The amount of the additional distance shall be chosen according to a vehicle design and application. assembly fastening means 4 4 are used to fasten hub cover 5 5 upon an energy wheel hub assembly, thereby holding together all the components. assembly fastening means 4 may be used in any way but must be arranged so that an energy wheel is balanced. A wheel drive shaft 8 8 may be rigidly attached to an inner wheel rotor 1 1 and hub cover 5 5 in any prior art shaft attachment manner required.

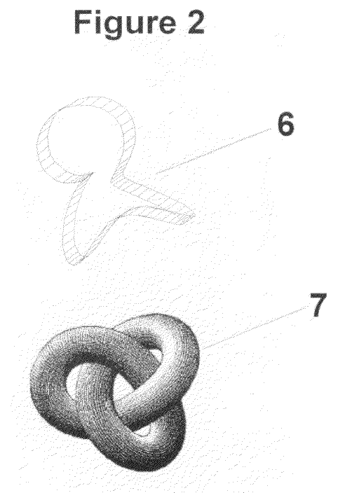

FIG. 2 is a front view of a three by one elastic trefoil strip 6 and elastic trefoil knot 7. As is known in the field of geometry and topology there exist an infinite number of M by N trefoil forms, any one of which is ideally suited for use as elastic spring means 3. Said elastic trefoil strip 6 6 or elastic trefoil knot 7 7 may be used for elastic spring means 3 3, placed between inner wheel rotor 1 1 and outer wheel hub rotor 2 2.

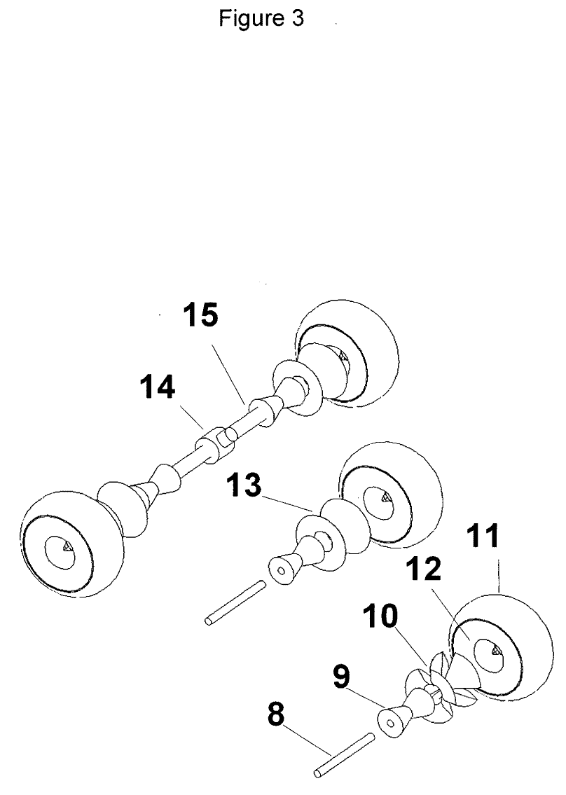

FIG. 3 is a perspective view of a single wheel split. segment elastic bag 10 energy wheel, a single segment elastic bag 13 energy wheel, and alternative dual wheel elastic bag energy wheel. Split segment increases maximum displacement between inner wheel rotor 1 and outer wheel hub rotor 2 versus single segment elastic bag 13. Both of the elastic bags may be internally hollow or solid. When hollow elastic bags may be filled with air and allow for greater displacement distance. A conjunction joint 14 rotatably holding a conjunction drive shaft 15 allows use of two energy wheels in cooperation while keeping the rotational speed of the two wheels at all times equal. Alternatively, a differential drive may be used in place of conjunction joint 14.

A plurality of elastic spring means 3 shall be used and may be any material or assembly having elastic properties sufficient for supporting a vehicles weight. Elastic properties refers to the property of force being proportional to an applied displacement distance. Thus electromagnetic and atomic elastic spring means 3 may be used. elastic spring means 3 must be arranged radially symmetric around inner wheel rotor 1 so that the combined energy wheel elasticity is at all times radially symmetric, otherwise a wobble effect will arise. elastic spring means 3 may be placed in any way such that a displacement between inner wheel rotor 1 and outer wheel hub rotor 2 results in a force directed radially toward the center of inner wheel rotor 1.

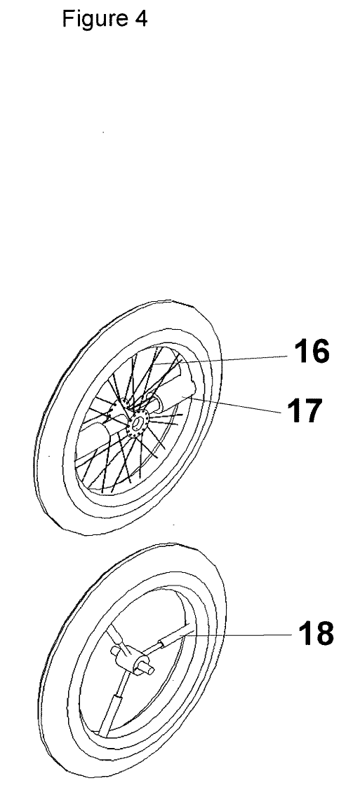

Many alternative elastic spring means 3 may be used between inner wheel rotor 1 and outer wheel hub rotor 2 or an included internal inner wheel rotor 20. When incorporating internal inner wheel rotor 20 with elastic spring means 3 within, the wheel rim and tire 11 operate as outer wheel hub. A tire 11 on an energy wheel is required to function only to provide road traction since elastic spring means 3 provide for shock absorption. There is no need for air filled tires and in fact, air filled tires reduce the energy wheels functional energy return properties. Intermediary rotors provide improved radial and axial rigidity. An alternate inner wheel rotor 9 may be used for alternate configurations so as to accommodate, for example, said single segment elastic bag 13 or a split segment elastic bag 10. FIG. 4 is an isometric view which shows how alternatively elastic cord 16 may be fastened between a wheel rim and outer wheel hub rotor 2 or alternate outer wheel hub rotor 12. A slide cylinder 17 shall be used with elastic cord 16 embodiment so as to increase radial and axial rigidity. Said slide cylinder 17 comprises two concentric, slidably connected cylinders. Alternatively, an elastic spring cylinder 18 may be used between inner wheel rotor 1 and a wheel rim or internal inner wheel rotor 20. elastic spring cylinder 18 may be replaced by elastic bar 22, curved elastic bar 23 or a toroidal spring 19.

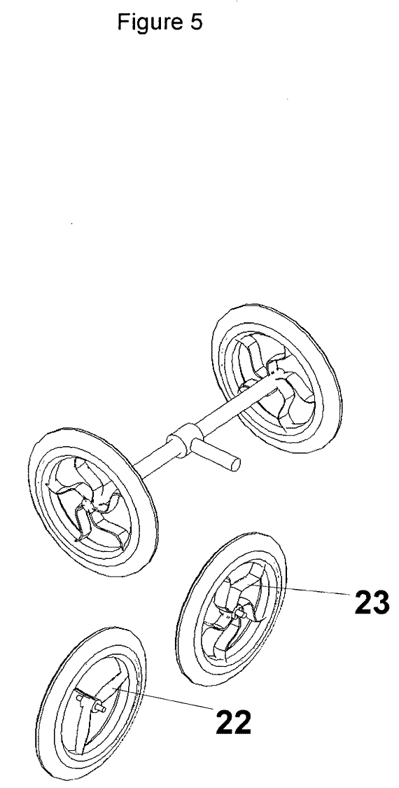

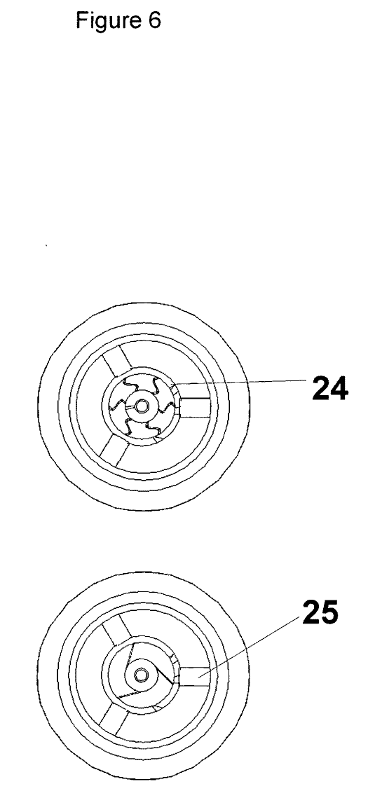

FIG. 5 is an isometric view of straight elastic bar 22 spring energy wheel, curved elastic bar 23 energy wheel, and alternative dual wheel elastic bar 22 energy wheel. When using elastic bar 22, singular points of radial non-elasticity within an energy wheel are avoided by arranging a plurality of elastic bar 22 radially symmetric along circular chords of an energy wheel. Furthermore, elastic bar 22 22 shall partially wrap around inner wheel rotor 1 1 to allow positional variance of inner wheel rotor 1 1 relative to outer wheel hub rotor 2 2. Curved elastic bar 23 has the same effect of eliminating singular points of radial non-elasticity and may be curved in any manner and arranged such that radial symmetry is preserved within the energy wheel. FIG. 6 is an exemplary front view of external inner wheel rotor 24 configuration with elastic bar 22 springs within, including a plurality of outer rotor supports 25, rigidly attached around, providing radial and axial rigidity.

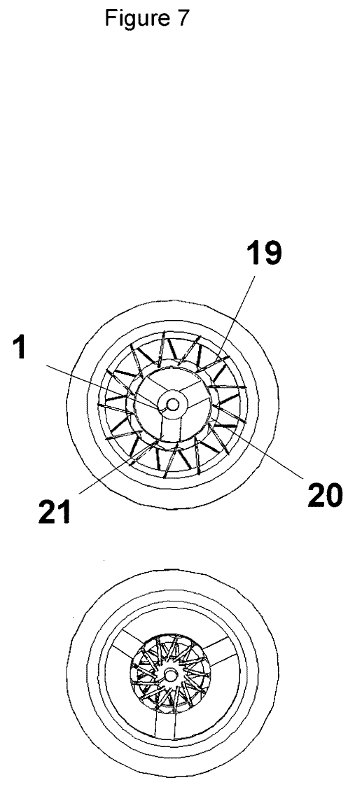

FIG. 7 which is a front view of two exemplary, toroidally configured energy wheels in an external inner wheel rotor 24 (bottom) configuration. Additionally, a plurality of outer rotor supports 25 are rigidly attached within external inner wheel rotor 24, providing radial and axial rigidity. Also shown in FIG. 7 is a toroidally configured energy wheel in said internal inner wheel rotor 20 (top) configuration with a plurality of inner rotor supports 21 (bottom), providing radial and axial rigidity.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An energy wheel for absorbing road bump shocks and converting into forward push. comprising:
means for fastening with elastic spring means and to connect with a drive shaft or conjunction drive shaft;
means for containing elastic spring means and operate as a wheel rim with attached tire, connect to a wheel rim or be nested within a secondary energy wheel;
means for performing the function of energy conservation, shock absorption and wheel support having a plethora of forms with combined elasticity being radially symmetric, rigidly connected to said means for containing elastic spring means and operate as a wheel rim with attached tire, connect to a wheel rim, or be nested within a secondary energy wheel, and rigidly connected to said means for fastening with elastic spring means and to connect with a drive shaft or conjunction drive shaft;
means for fastening the energy wheel assembly and must be arranged so that an energy wheel is balanced, removably connected to said means for fastening with elastic spring means and to connect with a drive shaft or conjunction drive shaft;
means for containing elastic spring means between inner wheel rotor and outer wheel hub rotor when elastic spring means are not rigidly fastened, removably connected to said means for fastening with elastic spring means and to connect with a drive shaft or conjunction drive shaft;
means for operation as radially symmetric elastic spring means providing a high degree of rigidity with minimal parts, rotatably engaged to said means for fastening with elastic spring means and to connect with a drive shaft or conjunction drive shaft;
means for operation as radially symmetric elastic spring means providing a high degree of rigidity with minimal parts, rotatably encircling to said means for fastening with elastic spring means and to connect with a drive shaft or conjunction drive shaft;
means for attachment of energy wheel to a vehicle drivetrain;
means for holding firmly an elastic bag or split segment elastic bag, rigidly connected to said means for attachment of energy wheel to a vehicle drivetrain;
means for placing around alternate inner wheel rotor and within alternate outer wheel hub rotor and perform energy conversion, shock absorption and wheel support, increasing maximum displacement between inner wheel rotor and outer wheel hub rotor, peripherally encircling to said means for holding firmly an elastic bag or split segment elastic bag;
means for providing traction with a driving surface;
means for containing elastic spring means and operate as a wheel rim with attached tire, connect to a wheel rim or be nested within a secondary energy wheel,
replaceably encircling to said means for providing traction with a driving surface, and snugly fitted to said means for placing around alternate inner wheel rotor and within alternate outer wheel hub rotor and perform energy conversion, shock absorption and wheel support, increasing maximum displacement between inner wheel rotor and outer wheel hub rotor;
means for placing around alternate inner wheel rotor and within alternate outer wheel hub rotor and perform energy conversion, shock absorption and wheel support,
snugly fitted to said means for containing elastic spring means and operate as a wheel rim with attached tire, connect to a wheel rim, or be nested within a secondary energy wheel,
and snugly encircling to said means for holding firmly an elastic bag or split segment elastic bag;
means for for holding rollably or being geared for drive with a conjunction drive shaft;
means for joining two energy wheels for simultaneous operation, evenly distributing imparted rotational acceleration of one wheel upon the dual wheel conjunction, rollably attached to said means for for holding rollably or being geared for drive with a conjunction drive shaft, and rigidly connected to said means for holding firmly an elastic bag or split segment elastic bag;
means for fastening with inner wheel rotor and outer wheel hub or rim performing energy conservation, shock absorption and wheel support having a plethora of forms and elastic materials with total combined elasticity being radially symmetric, pivotally connected to said means for containing elastic spring means and operate as a wheel rim with attached tire, connect to a wheel rim, or be nested within a secondary energy wheel;
means for providing axial rigidity and support of an energy wheel not provided by elastic spring means, rigidly connected to said means for holding firmly an elastic bag or split segment elastic bag;
means for fastening with inner wheel rotor and outer wheel rim, performing energy conservation, shock absorption and wheel support having a plethora of forms with combined elasticity being radially symmetric, rigidly connected to said means for holding firmly an elastic bag or split segment elastic bag;
means for performing the function of energy conservation, shock absorption and wheel support having a plethora of radially symmetric forms with combined elasticity being radially symmetric;
means for intermediary inner wheel rotor providing radial and axial rigidity and decreasing overall energy wheel weight, allowing multiple energy wheel nesting for increased energy conversion, shock absorption and rigidity, rigidly connected to said means for performing the function of energy conservation, shock absorption and wheel support having a plethora of radially symmetric forms with combined elasticity being radially symmetric, and structurally connected to said means for fastening with elastic spring means and to connect with a drive shaft or conjunction drive shaft;
means for supporting intermediary inner wheel rotor with inner wheel rotor and providing radial and axial rigidity, rigidly connected to said means for intermediary inner wheel rotor providing radial and axial rigidity and decreasing overall energy wheel weight, allowing multiple energy wheel nesting for increased energy conversion, shock absorption and rigidity;
means for fastening with inner wheel rotor and outer wheel rim and performing energy conversion;
means for intermediary inner wheel rotor providing radial and axial rigidity and decreasing overall energy wheel weight, allowing multiple energy wheel nesting for increased energy conversion, shock absorption and rigidity, rigidly connected to said means for fastening with inner wheel rotor and outer wheel rim and performing energy conversion; and
means for supporting intermediary inner wheel rotor with wheel rim and providing radial and axial rigidity, rigidly connected to said means for intermediary inner wheel rotor providing radial and axial rigidity and decreasing overall energy wheel weight, allowing multiple energy wheel nesting for increased energy conversion, shock absorption and rigidity.

2. The energy wheel in accordance with claim 1, wherein said means for fastening with elastic spring means and to connect with a drive shaft or conjunction drive shaft. comprises an inner wheel rotor.

3. The energy wheel in accordance with claim 1, wherein said means for containing elastic spring means and operate as a wheel rim with attached tire, connect to a wheel rim, or be nested within a secondary energy wheel. comprises an outer wheel hub rotor.

4. The energy wheel in accordance with claim 1, wherein said means for performing the function of energy conservation, shock absorption and wheel support having a plethora of forms with combined elasticity being radially symmetric. comprises an elastic spring means.

5. The energy wheel in accordance with claim 1, wherein said means for fastening the energy wheel assembly and must be arranged so that an energy wheel is balanced. comprises an assembly fastening means.

6. The energy wheel in accordance with claim 1, wherein said means for containing elastic spring means between inner wheel rotor and outer wheel hub rotor when elastic spring means are not rigidly fastened. comprises a hub cover.

7. The energy wheel in accordance with claim 1, wherein said means for operation as radially symmetric elastic spring means providing a high degree of rigidity with minimal parts. comprises an elastic trefoil strip.

8. The energy wheel in accordance with claim 1, wherein said means for operation as radially symmetric elastic spring means providing a high degree of rigidity with minimal parts. comprises an elastic trefoil knot.

9. The energy wheel in accordance with claim 1, wherein said means for attachment of energy wheel to a vehicle drivetrain. comprises a drive shaft.

10. The energy wheel in accordance with claim 1, wherein said means for holding firmly an elastic bag or split segment elastic bag. comprises an alternate inner wheel rotor.

11. The energy wheel in accordance with claim 1, wherein said means for placing around alternate inner wheel rotor and within alternate outer wheel hub rotor and perform energy conversion, shock absorption and wheel support, increasing maximum displacement between inner wheel rotor and outer wheel hub rotor. comprises a split segment elastic bag.

12. The energy wheel in accordance with claim 1, wherein said means for providing traction with a driving surface. comprises a tire.

13. The energy wheel in accordance with claim 1, wherein said means for containing elastic spring means and operate as a wheel rim with attached tire, connect to a wheel rim, or be nested within a secondary energy wheel.
comprises an alternate outer wheel hub rotor.

14. The energy wheel in accordance with claim 1, wherein said means for placing around alternate inner wheel rotor and within alternate outer wheel hub rotor and perform energy conversion, shock absorption and wheel support.
comprises a single segment elastic bag.

15. The energy wheel in accordance with claim 1, wherein said means for for holding rollably or being geared for drive with a conjunction drive shaft. comprises a conjunction joint.

16. The energy wheel in accordance with claim 1, wherein said means for joining two energy wheels for simultaneous operation, evenly distributing imparted rotational acceleration of one wheel upon the dual wheel conjunction. comprises a conjunction drive shaft.

17. The energy wheel in accordance with claim 1, wherein said means for fastening with inner wheel rotor and outer wheel hub or rim performing energy conservation, shock absorption and wheel support having a plethora of forms and elastic materials with total combined elasticity being radially symmetric. comprises an elastic cord.

18. The energy wheel in accordance with claim 1, wherein said means for providing axial rigidity and support of an energy wheel not provided by elastic spring means. comprises a slide cylinder.

19. The energy wheel in accordance with claim 1, wherein said means for fastening with inner wheel rotor and outer wheel rim, performing energy conservation, shock absorption and wheel support having a plethora of forms with combined elasticity being radially symmetric. comprises an elastic spring cylinder.

20. The energy wheel in accordance with claim 1, wherein said means for performing the function of energy conservation, shock absorption and wheel support having a plethora of radially symmetric forms with combined elasticity being radially symmetric. comprises a toroidal spring.

21. The energy wheel in accordance with claim 1, wherein said means for intermediary inner wheel rotor providing radial and axial rigidity and decreasing overall energy wheel weight, allowing multiple energy wheel nesting for increased energy conversion, shock absorption and rigidity. comprises an internal inner wheel rotor.

22. The energy wheel in accordance with claim 1, wherein said means for supporting intermediary inner wheel rotor with inner wheel rotor and providing radial and axial rigidity. comprises an inner rotor supports.

23. The energy wheel in accordance with claim 1, wherein said means for fastening with inner wheel rotor and outer wheel rim and performing energy conversion. comprises an elastic bar.

24. The energy wheel in accordance with claim 1, wherein said means for intermediary inner wheel rotor providing radial and axial rigidity and decreasing overall energy wheel weight, allowing multiple energy wheel nesting for increased energy conversion, shock absorption and rigidity. comprises an external inner wheel rotor.

25. The energy wheel in accordance with claim 1, wherein said means for supporting intermediary inner wheel rotor with wheel rim and providing radial and axial rigidity. comprises an outer rotor supports.

26. An energy wheel for absorbing road bump shocks and converting into forward push. comprising:
an inner wheel rotor, for fastening with elastic spring means and to connect with a drive shaft or conjunction drive shaft;
an outer wheel hub rotor, for containing elastic spring means and operate as a wheel rim with attached tire, connect to a wheel rim, or be nested within a secondary energy wheel;
an elastic spring means, for performing the function of energy conservation, shock absorption and wheel support having a plethora of forms with combined elasticity being radially symmetric, rigidly connected to said outer wheel hub rotor, and rigidly connected to said inner wheel rotor;
an assembly fastening means, for fastening the energy wheel assembly and must be arranged so that an energy wheel is balanced, removably connected to said inner wheel rotor;
a hub cover, for containing elastic spring means between inner wheel rotor and outer wheel hub rotor when elastic spring means are not rigidly fastened, removably connected to said inner wheel rotor;
an elastic trefoil strip, for operation as radially symmetric elastic spring means providing a high degree of rigidity with minimal parts, rotatably engaged to said inner wheel rotor;
an elastic trefoil knot, for operation as radially symmetric elastic spring means providing a high degree of rigidity with minimal parts, rotatably encircling to said inner wheel rotor;
a drive shaft, for attachment of energy wheel to a vehicle drivetrain;
an alternate inner wheel rotor, for holding firmly an elastic bag or split segment elastic bag, rigidly connected to said drive shaft;
a split segment elastic bag, for placing around alternate inner wheel rotor and within alternate outer wheel hub rotor and perform energy conversion, shock absorption and wheel support, increasing maximum displacement between inner wheel rotor and outer wheel hub rotor, peripherally encircling to said alternate inner wheel rotor;
a tire, for providing traction with a driving surface;
an alternate outer wheel hub rotor, for containing elastic spring means and operate as a wheel rim with attached tire, connect to a wheel rim, or be nested within a secondary energy wheel,
replaceably encircling to said tire, and snugly fitted to said split segment elastic bag;
a single segment elastic bag, for placing around alternate inner wheel rotor and within alternate outer wheel hub rotor and perform energy conversion, shock absorption and wheel support,
snugly fitted to said alternate outer wheel hub rotor, and snugly encircling to said alternate inner wheel rotor;
a conjunction joint, for for holding rollably or being geared for drive with a conjunction drive shaft;
a conjunction drive shaft, for joining two energy wheels for simultaneous operation, evenly distributing imparted rotational acceleration of one wheel upon the dual wheel conjunction, rollably attached to said conjunction joint, and rigidly connected to said alternate inner wheel rotor;
an elastic cord, for fastening with inner wheel rotor and outer wheel hub or rim performing energy conservation, shock absorption and wheel support having a plethora of forms and elastic materials with total combined elasticity being radially symmetric, pivotally connected to said outer wheel hub rotor;
a slide cylinder, for providing axial rigidity and support of an energy wheel not provided by elastic spring means, rigidly connected to said alternate inner wheel rotor;
an elastic spring cylinder, for fastening with inner wheel rotor and outer wheel rim, performing energy conservation, shock absorption and wheel support having a plethora of forms with combined elasticity being radially synmetric, rigidly connected to said alternate inner wheel rotor;
a toroidal spring, for performing the function of energy conservation, shock absorption and wheel support having a plethora of radially symmetric forms with combined elasticity being radially symmetric;
an internal inner wheel rotor, for intermediary inner wheel rotor providing radial and axial rigidity and decreasing overall energy wheel weight, allowing multiple energy wheel nesting for increased energy conversion, shock absorption and rigidity, rigidly connected to said toroidal spring, and structurally connected to said inner wheel rotor;
an inner rotor supports, for supporting intermediary inner wheel rotor with inner wheel rotor and providing radial and axial rigidity, rigidly connected to said internal inner wheel rotor;
an elastic bar, for fastening with inner wheel rotor and outer wheel rim and performing energy conversion;
an external inner wheel rotor, for intermediary inner wheel rotor providing radial and axial rigidity and decreasing overall energy wheel weight, allowing multiple energy wheel nesting for increased energy conversion, shock absorption and rigidity, rigidly connected to said elastic bar; and
an outer rotor supports, for supporting intermediary inner wheel rotor with wheel rim and providing radial and axial rigidity, rigidly connected to said external inner wheel rotor.

27. The energy wheel as recited in claim 26, further comprising:
a curved elastic bar, for fastening with inner wheel rotor and outer wheel rim and performing energy conversion, rigidly connected to said external inner wheel rotor.

28. An energy wheel for absorbing road bump shocks and converting into forward push. comprising:
an inner wheel rotor, for fastening with elastic spring means and to connect with a drive shaft or conjunction drive shaft;
an outer wheel hub rotor, for containing elastic spring means and operate as a wheel rim with attached tire, connect to a wheel rim, or be nested within a secondary energy wheel;
an elastic spring means, for performing the function of energy conservation, shock absorption and wheel support having a plethora of forms with combined elasticity being radially symmetric, rigidly connected to said outer wheel hub rotor, and rigidly connected to said inner wheel rotor;
an assembly fastening means, for fastening the energy wheel assembly and must be arranged so that an energy wheel is balanced, removably connected to said inner wheel rotor;
a hub cover, for containing elastic spring means between inner wheel rotor and outer wheel hub rotor when elastic spring means are not rigidly fastened, removably connected to said inner wheel rotor;
an elastic trefoil strip, for operation as radially symmetric elastic spring means providing a high degree of rigidity with minimal parts, rotatably engaged to said inner wheel rotor;
an elastic trefoil knot, for operation as radially symmetric elastic spring means providing a high degree of rigidity with minimal parts, rotatably encircling to said inner wheel rotor;
a drive shaft, for attachment of energy wheel to a vehicle drivetrain;
an alternate inner wheel rotor, for holding firmly an elastic bag or split segment elastic bag, rigidly connected to said drive shaft;
a split segment elastic bag, for placing around alternate inner wheel rotor and within alternate outer wheel hub rotor and perform energy conversion, shock absorption and wheel support, increasing maximum displacement between inner wheel rotor and outer wheel hub rotor, peripherally encircling to said alternate inner wheel rotor;
a tire, for providing traction with a driving surface;
an alternate outer wheel hub rotor, for containing elastic spring means and operate as a wheel rim with attached tire, connect to a wheel rim, or be nested within a secondary energy wheel,
replaceably encircling to said tire, and snugly fitted to said split segment elastic bag;
a single segment elastic bag, for placing around alternate inner wheel rotor and within alternate outer wheel hub rotor and perform energy conversion, shock absorption and wheel support,
snugly fitted to said alternate outer wheel hub rotor, and snugly encircling to said alternate inner wheel rotor;
a conjunction joint, for for holding rollably or being geared for drive with a conjunction drive shaft;
a conjunction drive shaft, for joining two energy wheels for simultaneous operation, evenly distributing imparted rotational acceleration of one wheel upon the dual wheel conjunction, rollably attached to said conjunction joint, and rigidly connected to said alternate inner wheel rotor;
an elastic cord, for fastening with inner wheel rotor and outer wheel hub or rim performing energy conservation, shock absorption and wheel support having a plethora of forms and elastic materials with total combined elasticity being radially symmetric, pivotally connected to said outer wheel hub rotor;
a slide cylinder, for providing axial rigidity and support of an energy wheel not provided by elastic spring means, rigidly connected to said alternate inner wheel rotor;
an elastic spring cylinder, for fastening with inner wheel rotor and outer wheel rim, performing energy conservation, shock absorption and wheel support having a plethora of forms with combined elasticity being radially symmetric, rigidly connected to said alternate inner wheel rotor;
a toroidal spring, for performing the function of energy conservation, shock absorption and wheel support having a plethora of radially symmetric forms with combined elasticity being radially symmetric;
an internal inner wheel rotor, for intermediary inner wheel rotor providing radial and axial rigidity and decreasing overall energy wheel weight, allowing multiple energy wheel nesting for increased energy conversion, shock absorption and rigidity, rigidly connected to said toroidal spring, and structurally connected to said inner wheel rotor;
an inner rotor supports, for supporting intermediary inner wheel rotor with inner wheel rotor and providing radial and axial rigidity, rigidly connected to said internal inner wheel rotor;
an elastic bar, for fastening with inner wheel rotor and outer wheel rim and performing energy conversion;
a curved elastic bar, for fastening with inner wheel rotor and outer wheel rim and performing energy conversion;
an external inner wheel rotor, for intermediary inner wheel rotor providing radial and axial rigidity and decreasing overall energy wheel weight, allowing multiple energy wheel nesting for increased energy conversion, shock absorption and rigidity, rigidly connected to said curved elastic bar, and rigidly connected to said elastic bar; and
an outer rotor supports, for supporting intermediary inner wheel rotor with wheel rim and providing radial and axial rigidity, rigidly connected to said external inner wheel rotor.
